(19) United States
(12) Patent Application Publication
(10) Pub. No.: US 2025/0347005 A1
(43) Pub. Date: Nov. 13, 2025

(54) HYDROGEN PLASMOLYSIS

(71) Applicant: Tetronics Technologies Limited, Swindon (GB)

(72) Inventors: David Edward Deegan, Swindon (GB); Yiran Tang, Swindon (GB); Neil Edward Seth Charman, Swindon (GB); Peter Michael Keeley-Lopez, Swindon (GB)

(73) Assignee: Tetronics Technologies Limited, Swindon (GB)

(21) Appl. No.: 18/867,209

(22) PCT Filed: May 19, 2023
(86) PCT No.: PCT/EP2023/063518

§ 371 Date: Nov. 19, 2024

(30) Foreign Application Priority Data
May 19, 2022 (GB) 2207337.3

(51) Int. Cl. C25B 1/50; C25B 1/04; C25B 9/17; C25B 9/67

(52) U.S. Cl. CPC C25B 1/50; C25B 1/04; C25B 9/17; C25B 9/67

(57) ABSTRACT

The present invention relates to a method for the combined electrolytic and thermal production of hydrogen gas, the method comprising: (i) providing a plasma treatment unit having a plasma treatment chamber comprising first and second electrodes, and a first gas outlet in fluid communication with said plasma treatment chamber; wherein a base portion of the plasma treatment chamber forms a reservoir of an aqueous electrolyte; wherein the first electrode is comprised within a plasma torch whereby the plasma torch is arranged at a distance above a surface of the reservoir; and wherein the second electrode is submerged in the aqueous electrolyte; (ii) establishing a DC electric potential between the first and second electrodes whilst providing a flow of non-oxidising ionisable gas between the first electrode and the surface of the reservoir to generate and sustain a plasma arc therebetween, thereby producing hydrogen gas in the plasma treatment chamber; and (iii) recovering the hydrogen gas via the first gas outlet. The present invention also relates to a plasma treatment unit.

The present invention relates to a method for the combined electrolytic and thermal production of hydrogen gas (hydrogen plasmolysis) and a plasma treatment unit for hydrogen plasmolysis.

The major world economies are under pressure to transition from fossil-based energy generation to renewable sources, thus reducing the impact of human activities on the environment. Hydrogen is anticipated to play an important role in this shift, predominantly as a green fuel for energy intensive sectors such as aviation, international shipping, and large energy consuming foundation industries as a heat source, such as in glass, cement and steel production. Hydrogen is also a storable energy source which may smooth out the transient nature of energy supply from renewable energy sources such as photovoltaic panels and wind/tidal turbines. Hydrogen is also expected to be used for a wide range of vehicles, as is presently found in fuel cell electric vehicles, with heavy-duty transportation being the prime user.

There are several available technologies for hydrogen production. Presently, the most widely used technology is steam reformation of natural gas, which at the same time is the least environmentally friendly. The other commercially available technologies consist of different permutations of electrolysis such as alkaline electrolysis and proton exchange membrane (PEM) electrolysis. Due to the environmental and commercial (increasing cost of carbon as CO₂ emissions) implications, hydrogen production based on natural gas will need to be replaced by technologies driven by renewable energy sources, which will produce environmentally friendly hydrogen, so-called “green hydrogen”. The production cost of green hydrogen constitutes the main barrier for its deployment. One of the components driving the cost up is the efficiency and operating costs of hydrogen production processes, i.e. the cost of consumed electrical energy and chemical conversion efficiency. This invention relates to a process (and apparatus) for achieving enhanced water dissociation rates and efficiency, exploiting the thermal, electric, and chemical effects of plasma, for the large-scale commercial production of hydrogen gas.

Journal of Energy Engineering 132(3) 2006 “Hydrogen Production by Plasma Electrolysis” relates to a small-scale investigation of the feasibility of producing small stable atmospheric plasmas between DC electrodes and a water surface.

IOP Conf. Series: Materials Science and Engineering 162, 2017, 012010 “Hydrogen production by plasma electrolysis reactor of KOH-ethanol solution” relates to an electrolysis reactor of 1 litre capacity and the effects of voltage and cathode depth on plasma electrolysis were studied.

The Chinese Journal of Process Engineering 6(3), 2006, 396 “Experimental Study of Plasma Under-liquid Electrolysis in Hydrogen Generation” discloses a contact glow discharge electrolysis (CGDE) in which plasma is sustained by DC or pulsed DC glow discharges between an electrode and the surface of the surrounding electrolyte.

Jpn. J. Appl. Phys. 44(1A), 2005, 396 “Hydrogen Evolution by Plasma Electrolysis in Aqueous Solution” discloses an electrolysis cell of 1 litre capacity for plasma electrolysis. A tungsten cathode is separated from a platinum mesh anode by an inverted quartz glass funnel.

Journal of The Electrochemical Society 166(6), 2019, E181 “Effect of Competing Oxidizing Reactions and Transport Limitation on the Faradaic Efficiency in Plasma Electrolysis” studies the plasma electrolysis reduction of chloroacetate and ferricyanide.

WHEC 13-16 Jun. 2006-Lyon France “Hydrogen production by thermal water splitting using a thermal plasma” presents a brief state of the art of water thermal plasmas, showing the temperatures and quench velocity ranges technologically achievable. Thermodynamic properties of a water plasma are presented and discussed and a kinetic computational model is presented, describing the behaviour of splitted products during the quench in a plasma plume for various parameters, such as the quench rate.

WO 2008/141369 A1 relates to electrolysis of water for producing hydrogen and oxygen gas.

WO 2019/096880 A1 relates to a method and device for plasma-induced water splitting.

“Confirmation of anomalous hydrogen generation by plasma electrolysis” in 4^{th} Meeting of Japan CF Research Society, 2003 provides a study of hydrogen generation by an electrolysis cell.

Energy Sci. Eng. 9, 2021, 267 “Comprehensive assessment of hydrogen production in argon-water vapors plasmolysis” reports a simultaneous investigation of a theoretical and experimental analysis of hydrogen production from an atmospheric pressure argon-water vapor mixture as a function of DBD plasma applied voltage.

There remains a need in the art for a method and apparatus which allows for the commercial production of hydrogen gas. Despite the claimed success with small-scale laboratory sized tests there are significant gaps in the information, however they do demonstrate the feasibility of hydrogen gas production by, for example, plasma electrolysis. There are significant longevity, control, and therefore safety, considerations for commercial production due to the large volume of mixtures of hydrogen and oxygen gas being formed at elevated temperatures. The inventors developed the present invention with the aim of addressing these issues with the prior art or at least to provide a commercially viable alternative thereto.

In a first aspect of the present invention, there is provided a method for the combined electrolytic and thermal production of hydrogen gas, the method comprising:
(i) providing a plasma treatment unit having a plasma treatment chamber comprising first and second electrodes, and a first gas outlet in fluid communication with said plasma treatment chamber;
wherein a base portion of the plasma treatment chamber forms a reservoir of an aqueous electrolyte;
wherein the first electrode is comprised within a plasma torch whereby the plasma torch is arranged at a distance above a surface of the reservoir; and
wherein the second electrode is submerged in the aqueous electrolyte;
(ii) establishing a DC electric potential between the first and second electrodes whilst providing a flow of non-oxidising ionisable gas between the first electrode and the surface of the reservoir to generate and sustain a plasma arc therebetween, thereby producing hydrogen gas in the plasma treatment chamber; and
(iii) recovering the hydrogen gas via the first gas outlet.

The present disclosure will now be described further. In the following passages, different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous. In particular, the features disclosed in relation to the method may be combined with those described in relation to the plasma treatment unit suitable for carrying out the method, and vice versa.

The invention relates to a method for the combined electrolytic and thermal production of hydrogen gas. Such a method may simply be referred to herein as plasmolysis or the plasmolytic production of hydrogen gas.

The method comprises providing a plasma treatment unit, which may also be referred to as a plasmolysis cell. Preferably, the plasma treatment unit is that of the second aspect described herein. The unit has a plasma treatment chamber comprising first and second electrodes, and a first gas outlet in fluid communication with said plasma treatment chamber. A plasma treatment chamber refers to an enclosed space within which hydrogen plasmolysis may be carried out using the first and second electrodes. The cross section of the first electrode is preferably larger than the second electrode. A base portion of the plasma treatment chamber forms a reservoir of an aqueous electrolyte. That is, a base portion contains an aqueous electrolyte thereby forming a reservoir. Preferably, the base portion has a volume of at least 5 litres, even more preferably at least 10 litres. Such volumes permit the large-scale production of hydrogen gas but also require more safety considerations when compared to smaller scale feasibility studies due to the large volumes of potentially explosive gas mixtures. The first gas outlet permits the hydrogen rich gas generated within the plasma treatment chamber to be removed therefrom.

The first electrode is comprised within a plasma torch whereby the plasma torch is arranged at a distance above a surface of the reservoir. That is, a plasma torch comprises and provides the first electrode of use in the method and specifically, the first electrode is arranged at a suitable distance above the surface of the reservoir. Such a distance refers to the smallest separation between the electrode and the surface. Generally, the first electrode will be “rod” shaped and typically the distance is that to the tip of the electrode. The second electrode is submerged in the reservoir of aqueous electrolyte, such that at least a part of the electrode resides under the surface. Preferably, the second electrode is entirely immersed in the reservoir of aqueous electrolyte (i.e. the electrode is “underwater”).

Preferably an electromagnet may be provided proximate to the tip of the plasma torch. This may extend into the electrolyte. Provision of the electromagnet can be used to stabilise the plasma formed. In embodiments where the components have an annular concentric form, so to the electromagnet can be provided coaxial to the plasma torch.

Preferably, the aqueous electrolyte comprises alkali or alkaline earth metal salt and/or alcohol. For example, it is preferred that the aqueous electrolyte comprises sodium or potassium salt of hydroxide, carbonate and/or chloride, preferably hydroxide. Halides such as chloride are less preferred due to possible corrosion, equipment longevity and environmental impacts. It is also preferred that the electrolyte comprises an alcohol, preferably a C1-C6 alcohol, such as ethanol and/or methanol. Such additives are preferred for improving the overall efficiency of hydrogen production. The inventors have found there was a particular benefit wherein the electrolyte comprises at least 20 wt % alcohol, preferably at least 25 wt %, more preferably at least 30 wt % and/or up to 60 wt %, for example from 20 wt % to 60 wt %, preferably from 25 to 55 wt %.

Preferably, the conductivity of the electrolyte for hydrogen plasmolysis is at least 20 mS/cm and/or at most 130 mS/cm. In some embodiments, the electrolyte may have a low electrical conductivity, for example from 20 to 40 mS/cm and in other embodiments, the electrolyte may have a high electrical conductivity, for example from 80 to 130 mS/cm.

The method comprises establishing a DC electric potential between the first and second electrodes whilst providing a flow of non-oxidising ionisable gas between the first electrode and the surface of the reservoir to generate a plasma arc therebetween upon electrical breakdown, thereby producing hydrogen gas in the plasma treatment chamber; and recovering the hydrogen gas via the first gas outlet.

Establishing a DC electric potential means applying DC voltage across the first and second electrodes. So long as the DC voltage and flow of non-oxidising ionisable gas are sustained and current flows, so too is the plasma arc. Preferably, the first electrode is the cathode and the second electrode is the anode. Preferably the electric potential has a voltage of at least 30 V, preferably at least 300 V, more preferably at least 500 V. For example, the voltage may preferably range from 100 to 5,000 V, more preferably from 1,000 to 3,000 V, for example from 1,500 to 2,000 V. It is also preferred that the current is less than 100 A, preferably less than 50 A. Preferably, the current is at least 10 A. The inventors have found that such high-voltage and low-current is particularly suitable for large-scale hydrogen production by plasmolysis since these parameters are found to favour hydrogen gas production and minimise energy losses which is essential for commercial hydrogen gas production. Such parameters are broadly the inverse of those typical for other plasma applications whereby low-voltage and high-current is employed. Additionally, the low-current reduces the wear on the first electrode, for example reduces oxidation and/or etching. As such, the distance between the tip of the electrode and the surface of the aqueous electrolyte can be reliably controlled when carrying out the method, and over the lifetime of the electrode and the treatment unit thereby also reducing downtime. In the present method, preferably the energy consumption is less than 50 kWh per kg of hydrogen gas produced/recovered, preferably less than 45.

The voltage is applied whilst providing a flow of non-oxidising ionisable gas between the first electrode and the surface of the reservoir. The flow is preferably provided by the plasma torch. As a result of the high-voltage applied between the first and second electrodes, the second electrode being submerged in the aqueous electrolyte, this generates a plasma arc between the first electrode and the aqueous electrolyte in a co-called “transferred arc” mode, i.e. the arc bridging from the plasma device to the electrolyte. Preferably, the first electrode is arranged at a distance of from 0.1 to 50 mm from the surface of the reservoir, more preferably from 1 to 20 mm, more preferably 1 to 5 mm. In a preferred embodiment, the distance is varied whilst establishing the electric potential between the first and second electrodes. Preferably, the distance in increased from an initial distance during which time the plasma arc is established, to a greater distance for the plasmolysis reaction performed with the plasma arc. Greater distances are preferred because a longer plasma arc provides a greater voltage. Since Volts=Joules/Coulomb, a greater voltage affords greater energy for a given charge. The plasma arc may also be referred to as a “thermal arc”, “thermal plasma arc” or an “equilibrium plasma arc”.

The plasma torch generates a plasma arc which supplies the electrons required for reduction (electrolysis) and radiant heat (thermolysis). Hydrogen gas (together as a mixture with the non-oxidising ionisable gas and some oxygen gas) is generated by the plasmolysis. As such the gas generated is a hydrogen rich mixture of gases. The gases rise within the plasma treatment chamber and are recovered via the first gas outlet. Thereafter, the hydrogen gas may be easily segregated and purified, as may the oxygen gas. The non-oxidising ionisable gas may be recycled into the flow within the plasma treatment chamber. Preferably, the non-oxidising ionisable gas is helium, argon, nitrogen, hydrogen or a mixture thereof, helium, argon, nitrogen or a mixture thereof, and more preferably argon.

The present method mitigates the risks associated with the formation of a potentially explosive mixture of hydrogen and oxygen gas. These risks do not arise in small laboratory scale applications, but are critical when the process is scaled up industrially. The plasma arc has a steep thermal and pressure gradient which results in the expulsion of the products from the arc as they are produced. The introduction of a non-oxidising ionisable gas facilitates the continual extraction of the gaseous products and dilutes and cools the gases. The inventors also found that the non-oxidising ionisable gas may shield the electrode from oxidation and ultimately from disintegration of the electrode thereby minimising downtime and maximising longevity for the plasma treatment unit (plasmolysis cell). Preferably, the first and/or second electrodes are formed of thermally and chemically stable metals such as tungsten, molybdenum and/or platinum group metals. For example, it is preferred that the first electrode is formed of tungsten and/or molybdenum and the second electrode formed of a platinum groups metal such as platinum.

It is particularly preferred that the plasma torch comprises a nozzle defining an annular passage surrounding the first electrode and the flow of non-oxidising ionisable gas is provided through the annular passage of the plasma torch. This is particularly effective at minimising oxidation and erosion of the electrode. Preferably the plasma torch is a water-cooled plasma torch. Where a plasma torch comprises a nozzle, the nozzle may be water-cooled and/or the electrode may be water-cooled, preferably both. In other embodiments the plasma torch does not have a water-cooled nozzle, since this saves on cost and may not be required when operating at lower temperatures. Suitable plasma torches for use in the present invention may be known in the fields of extractive metallurgy and novel materials production, e.g. pure silica glass. One suitable plasma torch assembly is described in WO 2019/092416 A1 (the contents of which is incorporated herein in its entirety). The unique use of a plasma torch in the transferred arc manner described herein allows for safe production of a large volume of hydrogen gas whilst maintaining a relatively cool and safe working temperature for the diluted gases generated thereby avoiding any risk of dangerous explosion. The present method is therefore capable of producing up to 6000 g of hydrogen gas per hour per unit cell operation. This is an entry level industrially scaled cell which can be replicated for large unit installation capacities.

Alternatively, or additionally, the flow of non-oxidising ionisable gas is provided through one or more flowpaths angled above the surface of the reservoir. That is, one or more flowpaths (such as pipes) permit introduction of the non-oxidising ionisable gas through a wall of the plasma treatment unit and provide a flow of the gas across the surface of the reservoir to again dilute and aid in evacuation of the gaseous products with rapid cooling. Preferably the flow of non-oxidising ionisable gas maintains a temperature of the mixture of gases evolved within the plasma treatment unit at less than 250° C., preferably less than 200° C. The inventors were surprised to find that the flow of non-oxidising ionisable gas, together with the complementing voltage drop, may be used to sufficiently quench the hydrogen gas as it is formed and maintain a sufficiently ‘cold’ plasma treatment chamber so as to permit commercial production of hydrogen gas in a sufficiently safe manner.

Preferably, the method further comprises stirring the aqueous electrolyte. Stirring the aqueous electrolyte maintains homogeneity of the mixture and prevents localised overheating and reagent depletion during the plasmolysis. This ensures efficient heat and electron transfer from the plasma arc by reducing the diffusion layer thickness and minimises vapour concentration in the arc which could inhibit heat and mass transfer. Preferably, the method further comprises dosing the reservoir with water, and, optionally, further aqueous electrolyte, to maintain a substantially constant level of aqueous electrolyte. Preferably, a substantially constant concentration of aqueous electrolyte is maintained. In some embodiments, the temperature of the aqueous electrolyte during the method is maintained at 60° C. or more and/or 100° C. or less, for example from 70° C. to 80° C. Accordingly, it is also preferred that any water and optional further aqueous electrolyte that may be dosed to the reservoir has a temperature of 60° C. or more. In other embodiments, the temperature of the aqueous electrolyte during the method is maintained at 40° C. or less. At these reduced temperatures, the inventors have found that a water-cooled plasma torch may not be as desirable and removal of the water-cooled nozzle (and use of an uncooled nozzle, or a sheath) reduces the complexity of the first electrode and the propensity for side arcing.

Preferably, the plasma treatment chamber is divided into first and second sub-chambers by a gas-impermeable barrier arranged above the surface of, and submerged in, the reservoir;
wherein the first gas outlet is in fluid communication with the first sub-chamber and a second gas outlet is in fluid communication with the second sub-chamber;
wherein the first and second sub-chambers are in fluid communication via the reservoir of aqueous electrolyte; and
wherein the first electrode is arranged within the first sub-chamber and the second electrode is arranged in the reservoir below the second sub-chamber, whereby the hydrogen rich gas formed by the plasma rises into the first sub-chamber for recovery via the first gas outlet and oxygen enriched gas formed at the second electrode rises into the second sub-chamber for recovery via the second gas outlet.

In a second aspect of the present invention, there is provided a plasma treatment unit for the combined electrolytic and thermal production of hydrogen gas, the plasma treatment unit comprising:
(i) a plasma treatment chamber having a base portion for forming a reservoir of an aqueous electrolyte, the plasma treatment chamber divided into first and second sub-chambers by a gas-impermeable barrier extending into the base portion;
(ii) a first gas outlet in direct fluid communication with the first sub-chamber and a second gas outlet in direct fluid communication with the second sub-chamber; and
(iii) first and second electrodes connectable to a DC power supply, wherein the first electrode is comprised within a plasma torch;
wherein the plasma torch is arranged within the first sub-chamber and the second electrode is arranged in the base portion below the second sub-chamber so that, in use, the first electrode is arranged at a distance above a surface of the reservoir and the second electrode is submerged in the aqueous electrolyte.

The plasma treatment unit is preferably for the method described hereinabove. Specifically, the treatment chamber of the unit is divided into first and second sub-chambers, each having a gas outlet for recovering each of hydrogen and oxygen enriched gas which, when in use, are generated proximal to the first and second electrodes, respectively. That is, the first sub-chamber comprises the first gas outlet and second sub-chamber comprises the second gas outlet so that gases which generated from a reservoir of aqueous electrolyte added to the base portion in use can be recovered separately. It is preferred that at least one, and preferably both, of gas outlet process lines coupled to the respective gas outlets comprise a U-bend drain (i.e. a manometer type U-bend) to allow for condensate removal from the product gas steams and subsequent draining whilst avoiding air admittance to the chamber by the process of reverse flow.

The gas-impermeable barrier extending into the base portion ensures that, in use, the first and second sub-chambers are not in gaseous communication with one another. The inventors have found that the formation of a plasma results in a pressure differential between the first and second sub-chambers with the cathode cell (i.e. that preferably of the first sub-chamber comprising the first electrode) is pressurised pushing the level of the reservoir in the sub-chamber down. It was found that this can result in instability in the process and an oscillation of the electrolyte fluid level. Preferably, the plasma treatment unit further comprises an electrolyte level sensor, preferably an ultrasonic electrolyte level sensor. In one preferred embodiment, a purge gas is admitted to the anode cell (e.g. the second sub-chamber) to balance the pressure in order to reduce and/or eliminate undesirable oscillation of the levels of reservoir in each sub-chamber. The inventors have found that it is therefore preferable for the gas impermeable barrier to extend at least 15 mm, preferably from 20-50 mm into the base portion (below an electrolyte) in order to avoid gaseous communication of the two chambers.

As described in respect of the method, preferably the plasma torch is a water (or equivalently a thermal fluid) coolable plasma torch. Preferably the plasma torch comprises a nozzle defining an annular passage surrounding the first electrode, the annular passage connectable to a supply of non-oxidising ionisable gas and/or one or more flowpaths connectable to a supply of non-oxidising ionisable gas are arranged within the first sub-chamber at an angle with respect to the surface of the reservoir. Such a flowpath permits introduction of the non-oxidising ionisable gas through a side wall of the plasma treatment unit thereby providing an angle with respect to the surface of the reservoir, when in use, so as to be able to provide a flow of the gas across the surface of the reservoir.

Preferably, the gas-impermeable barrier is a wall made of an electrically insulating inorganic, refractory or polymeric material. The walls of the plasma treatment chamber, and in particular the gas impermeable barrier may comprise metallic components in their construction. In such case, it is preferred that the metallic components are coated with an electrically inert coating such as a ceramic (e.g. thermal ceramic spray coating or enamelled), in order to provide both mechanical and chemical robustness and also to aid in eliminating side arcs within the chamber. Such an electrically inert coating is preferably applied to both sides of the barrier and may also be applied to the nozzle/sheath of the first electrode. Examples of suitable coatings include alumina. Preferably, the plasma treatment chamber comprises a thermally and electrically insulating lining, preferably a refractory lining, and/or the chamber comprises external thermal insulation. Preferably, the base portion of the plasma treatment chamber comprises a glass and/or polymeric lining, preferably a composite glass and polymeric lining. In a preferred embodiment, the plasma treatment unit comprises means for waste heat recycling and/or recovery, for example means to recycle heat and pre-heat the additional fresh water/electrolyte to be dosed.

In a particularly preferred embodiment, the first and second electrodes are arranged concentrically, preferably coaxially, within the plasma treatment unit/chambers. Typically, the first electrode is arranged in the centre of the first sub-chamber and the second electrode is arranged concentrically in the base portion beneath the second sub-chamber. Preferably, the second electrode is therefore an annular electrode. Preferably, the second electrode is in the form of a mesh.

As will be appreciated, with a concentric arrangement of the electrodes, the first and second sub-chambers are preferably also arranged concentrically whereby the second sub-chamber of the plasma treatment unit surrounds the first sub-chamber. Such an arrangement of electrodes increases the operating efficiency of the unit (i.e. amount of hydrogen produced per unit of input power).

In some preferred embodiments, the plasma torch is housed within a an electrically insulative tube which extends down into the electrolyte (an end is electrolyte-immersed). When present, the tube must not divide the electrolyte into separate regions; rather the electrolyte must still freely flow within the base portion of the treatment chamber beneath both sub-chambers. This can be achieved by ensuring that the tube is supported above a bottom of the base portion. Quartz is a preferred material for the tube. The inventors have found that quartz is beneficial compared to other materials such as borosilicate glass due to the lower coefficient of thermal expansion (CTE) and is therefore more resistant to thermal shock and allows for better infrared transmission. The inventors found that the tube provides electrical isolation preventing short-circuiting of the process and increasing safety. Using a chemically resistant material and the change in materials of construction improve its resistance to thermal shock phenomena.

Preferably, the plasma treatment unit comprises a stirrer arranged in the base portion. Preferably, the plasma treatment unit further comprises means for introducing water and/or aqueous electrolyte into the base portion. The means can be used to dose the reservoir to maintain a substantially constant level and/or concentration of aqueous electrolyte.

Preferably, the plasma torch is movable within the first sub-chamber so that, in use, the distance between the first electrode and the surface of the reservoir can be varied whilst establishing an electric potential (and current flow) between the first and second electrodes and maintaining the plasma arc. In some embodiments the plasma torch may contact the electrolyte during a start-up phase of use.

In a preferred embodiment, the plasma treatment unit further comprises condensation units arranged within the first sub-chamber so that, in use, the condensation units condense water vapour contained within the mixture of gases generated. Such condensation units may also serve to aid in maintaining a temperature within the treatment chamber of less than 250° C. The gas outlet process lines are preferably water-cooled in order to further condense any moisture that exits the chamber through the gas outlets.

In another aspect, the present invention provides a hydrogen generation system which comprises a plurality of plasma treatment units which may be plumbed together to provide higher resulting unit capacities.

### FIGURES

The present invention will now be described further with reference to the following non-limiting Figures, in which:

FIG. 1 illustrates a cross-section of a plasma treatment unit according to the present invention when in use.

FIG. 2 illustrates a cross-section of a plasma torch suitable for use in the present invention.

FIGS. 3-6 provide plots of the hydrogen product rate, hydrogen flow, hydrogen concentration and concentration of byproducts as measured for different concentrations of methanol in an aqueous electrolytic in the example.

FIG. 7 illustrates a cross-section of an exemplary plasma treatment unit comprising a concentric arrangement of a second electrode.

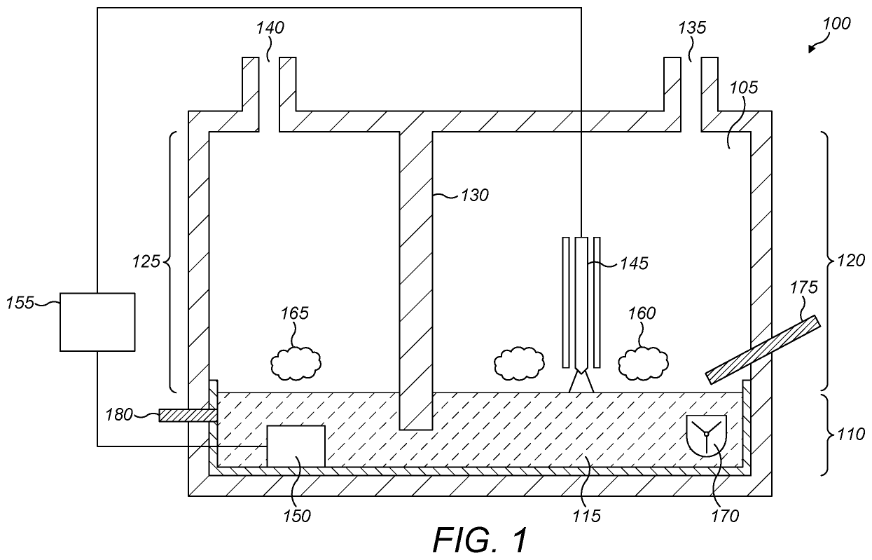

FIG. 1 illustrates a cross-section of a plasma treatment unit 100 suitable for hydrogen plasmolysis. The plasma treatment unit 100 comprises a plasma treatment chamber 105 that is divided into a first sub-chamber 120, a second sub-chamber 125 and a base portion 110 directly beneath the first and second sub-chambers 120, 125. The base portion 110 has lining formed of polymeric, or other thermally and chemically compatible, material forming a reservoir of an aqueous electrolyte 115, for example, an aqueous solution comprising sodium hydroxide and ethanol and/or methanol. The upper surface of the reservoir of aqueous electrolyte 115 in use may serve to define the boundary between the base portion 110 and first and second sub-chambers 120, 125.

The first sub-chamber 120 is separated and divided from the second sub-chamber 125 by a wall 130 formed of an inorganic material providing a gas-impermeable barrier. The wall 130 extends into the base portion 110 so that in use, the wall extends into the reservoir 115.

The plasma treatment unit 100 comprises a first gas outlet 135 that is directly in fluid communication with the first sub-chamber 120 (i.e. not via the base portion). Equally, the unit 100 comprises a second gas outlet 140 in direct fluid communication with the second sub-chamber 125. A first electrode 145 is comprised within a plasma torch that is arranged in the first sub-chamber 120 so that the first electrode 145 is arranged at a distance, for example about 1 mm, above the upper surface of the reservoir 115. The plasma torch is arranged in a generally vertical position so that a tip of the first electrode 145 from which the plasma arc is to be generated is at the distance above the surface of the reservoir 115. A second electrode 150 is entirely immersed in the reservoir of an aqueous electrolyte 115 directly beneath the second sub-chamber 125, though the second electrode 150 may instead be submerged with a portion of the second electrode 150 therefore extending into the second sub-chamber 125. The first and second electrodes 145, 150 are connected to a DC plasma power supply 155 such that the first electrode 145 is the cathode, and the second electrode 150 the anode.

In use, a flow of non-oxidising ionisable gas is provided (not shown) between the first electrode 145 and the upper surface of the reservoir 115 and a high voltage electric potential of more than 1,000 V is applied in order to generate and maintain a plasma arc therebetween. After an initial time period within which the plasma arc is established, the distance of the first electrode 145 to the surface of the reservoir 115 is increased, for example, to about 10 mm, whilst maintaining the high voltage electric potential and therefore the plasma arc.

As a result, hydrogen rich gas 160 is produced by the interaction of the plasma arc and aqueous electrolyte which rises into the first sub-chamber 120 and is then recovered via the first gas outlet 135. As will be appreciated, a mixture of gases will evolve during plasmolysis which will fill the first sub-chamber after continued operation. In some preferred embodiments, the plasma treatment unit 100 comprises one or more condensation units arranged within the first sub-chamber 120 in order to condense any water vapour that is generated during the plasmolysis. At the same time, oxygen gas 165 is generated at the second electrode and rises into the second sub-chamber 125, and which may be independently recovered from the hydrogen rich gas 160, via the second gas outlet 140.

The plasma treatment unit 100 further comprises a stirrer 170 arranged in the base portion 110 so that in use, the reservoir of aqueous electrolyte 115 may be stirred. The unit 100 also comprises means 180 for introducing water and/or aqueous electrolyte into the base portion, for example, a pipe that is arranged through a wall of the unit 100 and into the base portion 115.

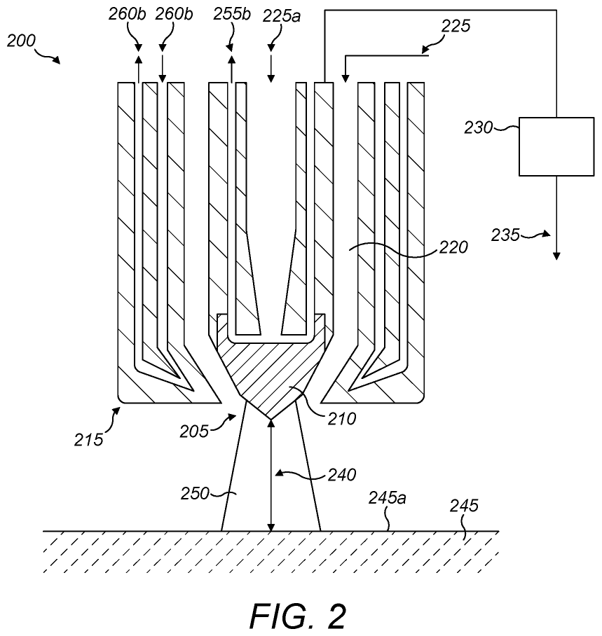

Whilst the flow of non-oxidising ionisable gas may be provided via the plasma torch, as described further with respect to FIG. 2 below, the unit 100 may also comprise one or more flowpaths 175, such as pipes, that pass through a side wall of the unit 100 and are therefore arranged within the first sub-chamber 120 at an angle with respect to the surface of the reservoir 115. In use, the flow of non-oxidising ionisable gas between the first electrode and the surface of the reservoir may be provided through the flowpath 175.

FIG. 2 illustrates a cross-section of the working end, inclusive of the electrode tip, of a cylindrical plasma torch 200. Plasma torch 200 is suitable for use in the plasma treatment unit 100 shown in FIG. 1 and comprises an electrode 205 that has a tungsten tip 210. The plasma torch 200 further comprises a nozzle 215 that defines an annular passage 220 that surrounds the electrode 205 through which a flow of non-oxidising ionisable gas 225, preferably argon, may be supplied. The electrode 205 is connected to a DC power supply 230 which in turn is connected 235 to a second electrode (not shown) of the plasmolysis cell.

When in use, such as is shown in FIG. 1, the tungsten tip 210 is arranged at a distance 240 above a surface 245a of a reservoir of aqueous electrolyte 245, and application of a high voltage DC electric potential to the first electrode 205 and second electrode, together with providing the flow of argon gas 225, support the maintenance of a plasma arc 250 that is generated between the electrode 205 and the surface 245a, which in turn results in the production of hydrogen rich gas (i.e. hydrogen plasmolysis).

The plasma torch 200 is actively cooled. Both the electrode 205 and the nozzle 215 may be cooled by a supply of cooling fluid, preferably water. The electrode has a cooling water supply 255a and a cooling water return 255b and equally the nozzle has a cooling water supply 260a and a cooling water return 260b formed by flowpaths within the electrode and nozzle, respectively. Water cooling increases the lifetime of the electrode by reducing wear and degradation of the tungsten tip by allowing them to run cold.

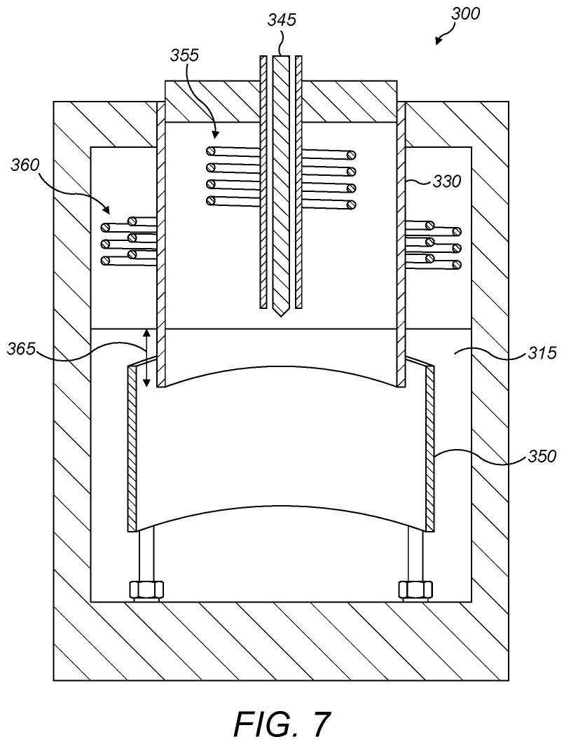

FIG. 7 illustrates a cross-section of a plasma treatment unit 300 suitable for hydrogen plasmolysis. The plasma treatment unit 300 comprises a plasma treatment chamber that is divided into a first and second sub-chambers, wherein each sub-chamber has a condensation unit 355, 360 arranged therein so as to, when in use, condense water vapour contained within the mixture of gases generated in each sub-chamber. Each condensation unit 355, 360 is a series of condensation pipes which are arranged concentrically in each sub-chamber.

Plasma treatment unit 300 comprises a first electrode within a plasma torch 345 arranged centrally within the first sub-chamber wherein the tip of the electrode of the plasma torch 345 is arranged above the surface of a reservoir of aqueous electrolyte 315. A gas impermeable barrier 330, which is a wall of the plasma treatment unit that is preferably coated with an electrically insulating ceramic, extends into the base portion of the treatment unit, and therefore the aqueous electrolyte 315 when in use. The barrier 330 extends a distance 365 below the surface of the aqueous electrolyte, preferably at least 20 mm. A second electrode 350 is a mesh arranged concentrically and entirely immersed in the aqueous electrolyte beneath the second sub-chamber of the treatment unit 300. Gas and aqueous electrolyte inlets and outlets are omitted for clarity.

A further quartz tube (not shown) may be provided within the gas impermeable barrier 330, extending around the plasma torch 345 and into the electrolyte 315. This helps to electrically isolate the first electrode from the second electrode.

### EXAMPLES

A plasma treatment unit comprising concentrically arranged first and second electrodes was used to carry out the method disclosed herein with varying amounts of alcohol, specifically methanol, in the aqueous electrolyte. These experiments were undertaken with an electrode conductivity of 20-40 mS/cm.

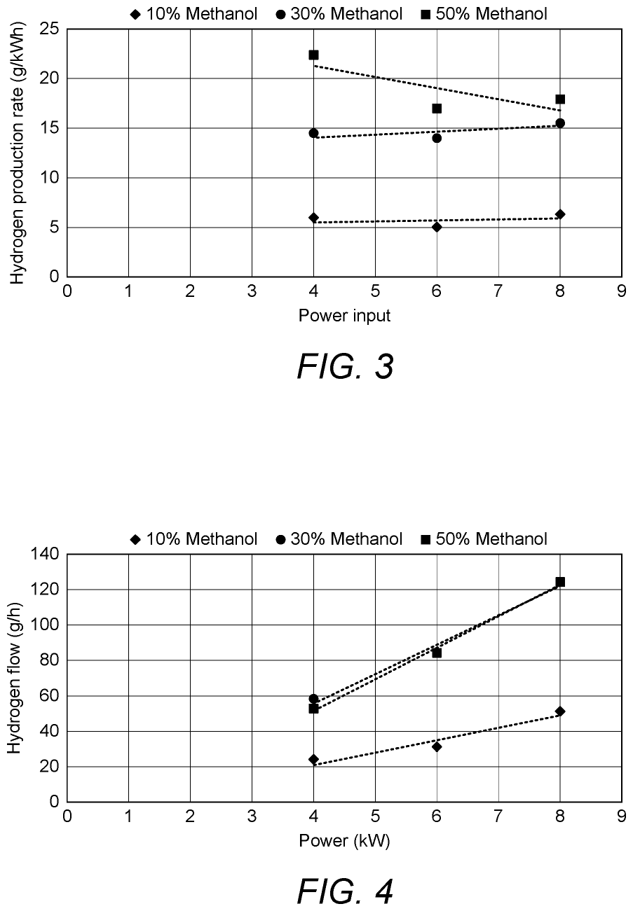

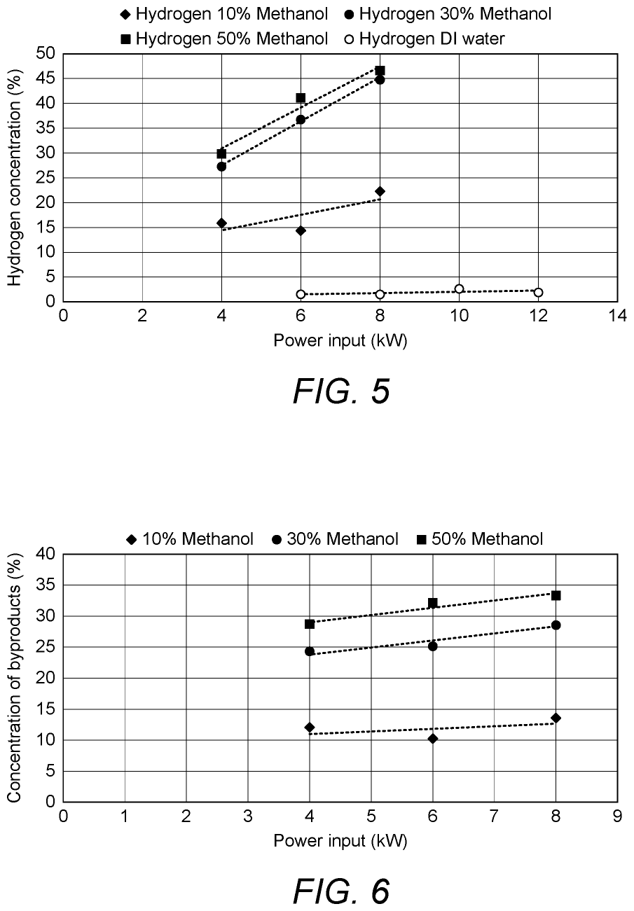

The hydrogen production rate at the first gas outlet, together with the hydrogen flow rate and hydrogen concentration, and the concentration of byproducts, was measured at varying power inputs ranging from 4 KW to 12 kW. The data is provided in the Tables below and in FIGS. 3-6.

### Specific Hydrogen Production:

| | Specific Hydrogen | | |
|---|---|---|---|
| | Production (g/kWh) | | |
| Power | DI water | | |
| (kW) | Median | Mean | Max |
| 4 | — | — | — |
| 6 | 0.53 | 0.60 | 1.19 |
| 8 | 0.58 | 0.53 | 0.87 |
| 10 | 0.10 | 0.25 | 0.86 |
| 12 | 0.10 | 0.25 | 1.07 |

| | Specific Hydrogen Production (g/kWh) | | | | | | | | |
|---|---|---|---|---|---|---|---|---|---|
| Power | 10% methanol | | | 30% methanol | | | 50% methanol | | |
| (kW) | Median | Mean | Max | Median | Mean | Max | Median | Mean | Max |
| 4 | 5.9 | 6.2 | 14.3 | 14.4 | 13.96 | 38.81 | 22.3 | 21.9 | 42.4 |
| 6 | 5.1 | 4.5 | 11.2 | 13.97 | 14.85 | 26.93 | 17.0 | 17.6 | 27.0 |
| 8 | 6.3 | 6.4 | 9.3 | 15.52 | 15.38 | 21.89 | 17.9 | 17.7 | 23.6 |
| 10 | — | — | — | — | — | — | — | — | — |
| 12 | — | — | — | — | — | — | — | — | — |

### Hydrogen Flow:

| | Hydrogen flow (g/h) | | |
|---|---|---|---|
| Power | DI water | | |
| (kW) | Median | Mean | Max |
| 4 | — | — | — |
| 6 | 3.39 | 3.76 | 7.20 |
| 8 | 4.69 | 4.31 | 7.38 |
| 10 | 1.01 | 2.64 | 8.94 |
| 12 | 1.30 | 3.07 | 13.75 |

| | Hydrogen flow (g/h) | | | | | | | | |
|---|---|---|---|---|---|---|---|---|---|
| Power | 10% methanol | | | 30% methanol | | | 50% methanol | | |
| (kW) | Median | Mean | Max | Median | Mean | Max | Median | Mean | Max |
| 4 | 24.0 | 25.1 | 66.1 | 58.4 | 57.1 | 158.6 | 53.4 | 55.7 | 158.6 |
| 6 | 30.5 | 26.9 | 68.9 | 84.5 | 90.2 | 163.2 | 84.5 | 90.2 | 163.2 |
| 8 | 51.2 | 52.5 | 75.5 | 124.7 | 123.8 | 177.1 | 124.7 | 123.8 | 177.1 |
| 10 | — | — | — | — | — | — | — | — | — |
| 12 | — | — | — | — | — | — | — | — | — |

Comparably the preliminary technology performance operating with high electrical conductivity electrolyte 80-130 mS/cm, without methanol additions, gave rise to the same level of hydrogen production but with a higher specific energy requirement. These data are provided below:

| | Specific Hydrogen | | |
|---|---|---|---|
| | Production (g/kWh) | | |
| Power | DI water | | |
| (kW) | Median | Mean | Max |
| 4 | 8.3 | 6.2 | 13.7 |
| 6 | 11.3 | 9.3 | 23.3 |
| 8 | 7.4 | 7.8 | 16.3 |

| | Hydrogen flow (g/h) | | |
|---|---|---|---|
| Power | DI water | | |
| (kW) | Median | Mean | Max |
| 4 | 33.5 | 25.1 | 56.2 |
| 6 | 67.5 | 55.7 | 130.4 |
| 8 | 59.4 | 62.6 | 128.3 |

As used herein, the singular form of “a”, “an” and “the” include plural references unless the context clearly dictates otherwise. The use of the term “comprising” is intended to be interpreted as including such features but not excluding other features and is also intended to include the option of the features necessarily being limited to those described. In other words, the term also includes the limitations of “consisting essentially of” (intended to mean that specific further components can be present provided they do not materially affect the essential characteristic of the described feature) and “consisting of” (intended to mean that no other feature may be included such that if the components were expressed as percentages by their proportions, these would add up to 100%, whilst accounting for any unavoidable impurities), unless the context clearly dictates otherwise.

It will be understood that, although the terms “first”, “second”, etc. may be used herein to describe various elements and/or portions and so forth, the elements, and/or portions should not be limited by these terms. These terms are only used to distinguish one element or portion from another, or a further, element or portion. Spatially relative terms, such as “under”, “below”, “beneath”, “lower”, “over”, “above”, “upper” and the like, may be used herein for ease of description to describe one element or feature's relationship to another element(s) or feature(s).

The foregoing detailed description has been provided by way of explanation and illustration, and is not intended to limit the scope of the appended claims. Many variations of the presently preferred embodiments illustrated herein will be apparent to one of ordinary skill in the art, and remain within the scope of the appended claims and their equivalents.

1. A method for the combined electrolytic and thermal production of hydrogen gas, the method comprising:
(i) providing a plasma treatment unit having a plasma treatment chamber comprising first and second electrodes, and a first gas outlet in fluid communication with said plasma treatment chamber;
wherein a base portion of the plasma treatment chamber forms a reservoir of an aqueous electrolyte;
wherein the first electrode is comprised within a plasma torch whereby the plasma torch is arranged at a distance above a surface of the reservoir; and
wherein the second electrode is submerged in the aqueous electrolyte;
(ii) establishing a DC electric potential between the first and second electrodes whilst providing a flow of non-oxidising ionisable gas between the first electrode and the surface of the reservoir to generate and sustain a plasma arc therebetween, thereby producing hydrogen gas in the plasma treatment chamber; and
(iii) recovering the hydrogen gas via the first gas outlet.

2. The method according to claim 1, wherein the plasma torch is a water-cooled plasma torch.

3. The method according to claim 1, wherein the plasma torch comprises a nozzle defining an annular passage surrounding the first electrode and the flow of non-oxidising ionisable gas is provided through the annular passage of the plasma torch, and/or wherein the flow of non-oxidising ionisable gas is provided through one or more flowpaths angled above the surface of the reservoir.

4. (canceled)

5. The method according to claim 1, wherein the flow of non-oxidising ionisable gas maintains a temperature of the mixture of gases evolved within the plasma treatment unit at less than 250° C.

6. The method according to claim 1, wherein the aqueous electrolyte comprises alkali or alkaline earth metal salt and/or alcohol.

7-9. (canceled)

10. The method according to claim 1, wherein the energy consumption is less than 50 kWh per kg of hydrogen gas produced.

11. The method according to claim 1, wherein the plasma treatment chamber is divided into first and second sub-chambers by a gas-impermeable barrier arranged above the surface of, and submerged in, the reservoir;
wherein the first gas outlet is in fluid communication with the first sub-chamber and a second gas outlet is in fluid communication with the second sub-chamber;
wherein the first and second sub-chambers are in fluid communication via the reservoir of aqueous electrolyte; and
wherein the first electrode is arranged within the first sub-chamber and the second electrode is arranged in the reservoir below the second sub-chamber, whereby the hydrogen gas formed by the plasma rises into the first sub-chamber for recovery via the first gas outlet and oxygen gas formed at the second electrode rises into the second sub-chamber for recovery via the second gas outlet.

12. The method according to claim 1, wherein the second electrode is entirely immersed in the reservoir of aqueous electrolyte.

13. The method according to claim 1, wherein the method further comprises stirring the aqueous electrolyte.

14. The method according to claim 1, wherein the method further comprises dosing the reservoir with water, and, optionally, further aqueous electrolyte, to maintain a substantially constant level of aqueous electrolyte.

15. The method according to claim 14, wherein the water and optional further aqueous electrolyte is dosed to the reservoir at a temperature of 60° C. or more.

16. A plasma treatment unit for the combined electrolytic and thermal production of hydrogen gas, the plasma treatment unit comprising:
(i) a plasma treatment chamber having a base portion for forming a reservoir of an aqueous electrolyte, the plasma treatment chamber divided into first and second sub-chambers by a gas-impermeable barrier extending into the base portion;
(ii) a first gas outlet in direct fluid communication with the first sub-chamber and a second gas outlet in direct fluid communication with the second sub-chamber; and
(iii) first and second electrodes connectable to a DC power supply, wherein the first electrode is comprised within a plasma torch;
wherein the plasma torch is arranged within the first sub-chamber and the second electrode is arranged in the base portion below the second sub-chamber so that, in use, the first electrode is arranged at a distance above a surface of the reservoir and the second electrode is submerged in the aqueous electrolyte.

17. The plasma treatment unit according to claim 16, wherein the plasma torch is a water-coolable plasma torch.

18. The plasma treatment unit according to claim 16,
wherein the plasma torch comprises a nozzle defining an annular passage surrounding the first electrode, the annular passage connectable to a supply of non-oxidising ionisable gas.

19. The plasma treatment unit according to claim 16, wherein one or more flowpaths connectable to a supply of non-oxidising ionisable gas are arranged within the first sub-chamber at an angle with respect to the surface of the reservoir.

20-23. (canceled)

24. The plasma treatment unit according to claim 16, wherein the plasma treatment unit further comprises means for introducing water and/or aqueous electrolyte into the base portion.

25. The plasma treatment unit according to claim 16, wherein the plasma torch is movable within the first sub-chamber so that, in use, the distance between the first electrode and the surface of the reservoir can be varied whilst establishing an electric potential between the first and second electrodes.

26. The plasma treatment unit according to claim 16, wherein the first and/or second electrodes are formed of tungsten, molybdenum and/or platinum group metals.

27. The plasma treatment unit according to claim 16, further comprising condensation units arranged within the first sub-chamber so that, in use, the condensation units condense water vapour contained within the mixture of gases generated.

28. The plasma treatment unit according to claim 16, wherein the base portion has a volume of at least 5 litres.
